(19) United States
(12) Patent Application Publication
(10) Pub. No.: US 2005/0108148 A1
(43) Pub. Date: May 19, 2005

(54) System and method of investing in a market

(76) Inventor: Charles Carlson, Valparaiso, IN (US)

Correspondence Address: Bell, Boyd & Lloyd LLC, P.O. Box 1135, Chicago, IL, 60690-1135, US

(21) Appl. No.: 10/980,417

(22) Filed: Nov. 2, 2004

Related U.S. Application Data
(60) Provisional application No. 60/520,337, filed on Nov. 17, 2003.

(51) Int. Cl. G06F 17/60

(52) U.S. Cl. 705/37

(57) ABSTRACT

A system and method directed to an investment strategy that focuses on buying the worst-performing stocks in terms of percentage price change over the last twelve months in the Dow Jones Industrial Average. Specifically, an investor in one embodiment buys one or more of the worst performers, holds the portfolio of stocks for twelve months and one day, re-balances the portfolio to include new worst-to-first performers, holds the portfolio for twelve months and one day, and so on. Other embodiments include variations in the strategy, such as shorting the best performing stocks, using stock options and exchange-traded funds instead of common stocks to create the portfolios, and using a ratio of stock price to two-hundred-day moving average price instead of the twelve-month price change in order to determine the best and worst performers.

### PRIORITY CLAIM

This application claims priority to and benefit of U.S. Provisional Application Ser. No. 60/520,337, filed Nov. 17, 2003, which is incorporated herein in its entirety.

### BACKGROUND OF THE INVENTION

Under conventional market theories, the stock market, as a result of the interplay between vast numbers of buyers and sellers, is considered to be an “efficient” market in which the laws of supply and demand ultimately determine the price of the stock. If there are more buyers than sellers for a particular stock, the price of the stock will rise. If there are more sellers than buyers, the stock price will fall. Proponents of the efficient market theory believe that, since all market participants have access to the same information about a stock, the price of a stock should reflect the knowledge and expectations of all investors. Thus, an investor should theoretically not be able to beat the market since there is no way for the investor to know something about a stock that is not already reflected in the price of the stock. For that reason, stock prices move in a random fashion as new information comes into the market and is quickly reflected in the stock price. However, market efficiency assumes all market participants behave in a rational fashion all of the time. Unfortunately, the human condition that ultimately decides stock prices does not lend itself to full-time rational thinking.

That humans behave irrationally when it comes to things financial has also gained momentum in the academic world in recent years. In fact, the Nobel Prize in Economic Sciences in 2002 went to a psychologist, not an economist. Daniel Kahneman, along with his long-time collaborator Amos Tversky, published a paper in 1979, “Prospect Theory: An Analysis of Decision Under Risk.” That paper formed the basis for the concept of “risk aversion”—the theory that people generally derive more pain from a loss than they do pleasure from a gain. The applications of this psychological study were far-reaching, especially in the areas of finance. For example, risk aversion is said to explain why investors tend to stick with losing stocks in order to avoid “locking up a loss” by selling.

Kahneman and Tversky also found that individuals tend to overweight recent data in making forecasts and judgments. Most decisions are made, in fact, with a tendency to focus on recent information, to extrapolate the near term into the long term. This tendency helps to explain the herd mentality on Wall Street—people buying winning stocks because they expect near-term winners to be long-term winners. Conversely, people sell stocks everyone else is selling simply because recent data (i.e., the stock is falling in price) influences their decisions.

A student of Kahneman, Richard Thaler, applied behavioral psychology to economics and finance to research “contrarian” investing. Contrarian investors buy investments that are out of favor with the general investing public. Contrarians believe that, if the essence of successful investing is buying stocks at cheap prices, then stocks that are being shunned by investors should represent the stocks offering the best value. Contrarian investment strategies can be successful because they take advantage of investor overreaction. This overreaction, according to behavioral psychologists, is partly a result of investors making bad projections about stock prices as a result of overweighting recent events. Of course, buying a stock that has fallen sharply will not make anyone money if it stays down forever. That is why contrarian investors must also depend on the concept of “mean reversion” or “reversion to the mean.”

The world around us, such as weather patterns, people's emotions, societal behavior, etc., tends to track some level of equilibrium, a steady state or mean. Occasionally, this steady state is disrupted. In the case of weather, tornadoes, hurricanes and floods occur. In the case of societal behavior, riots and looting occur. In the case of human emotions, the peaks and valleys caused by big events, such as marriage, children or death, occur. Indeed, in terms of thermodynamics, it requires too much energy for things to stay at the extremes. As the energy that created the extremes dissipates, things tend to revert to their steady state. Thus, in the short term, things have the ability to run to extremes. Like a rubber band that stretches and contorts when pressure is applied but returns to its relaxed state once the pressure ceases, over time things tend to revert to a state of equilibrium, the long-term average or mean. Therefore, reversion to the mean occurs because it is not natural for things to exist forever at their extremes. At some point, things tend to revert back to their mean.

In some sense, stock prices are subject to mean reversion. Stock prices are ultimately driven by the laws of supply and demand. Those laws can be disrupted over the short term based on pressures such as buyer emotions, fads, herd mentality, etc. Over time, however, certain stock prices tend to revert from extremes to their average trading level or stable value.

Mean reversion has important implications for investing, especially contrarian investing. Contrarians believe that if one buys stocks that have run to extremes on the downside or sell stocks that have run to extremes on the upside, one will eventually be rewarded when mean reversion returns the stocks to their long-term equilibrium price level. Reversion to the mean is really the basis for contrarian investing. Therefore, contrarians say that the best opportunities in investing in stocks are created when values have run to extreme levels and are ready to swing back to their long-term equilibrium level.

Just because a stock declines sharply in one year, however, does not make it an automatic candidate for success the following year. That point has been reinforced by the experience with technology stocks in recent years. To be sure, mean reversion/contrarian investing is not as simple as going out and buying any “under-valued” stock. For example, the last thing a contrarian wants to do is buy a cheap stock that gets cheaper and cheaper and cheaper and then becomes extinct. Indeed, bankruptcy is the bane of any contrarian investing strategy by stealing the time a stock needs to revert to its mean. Thus, one must identify those stocks where reversion to the mean is most likely to occur, such as stocks that have a long history of weathering economic ups and downs and stocks with an ample long-run trading history. For that reason, stocks that seem best situated for a mean-reversion strategy are large, seasoned, time-tested companies with sound finances and the ability to weather down cycles in the economy and stock market. When these stocks show extreme price declines or altered value, especially relative to some appropriate benchmark or stable value, smart investors buy.

A 2001 research paper by Jonathan Lewellen supports this logic. Lewellen's study looked at all stocks on the New York Stock Exchange, American Stock Exchange, and NASDAQ over a very long time period (1926 through 1998) and a shorter period (1946 through 1998). What he found was that mean reversion in stock prices is “stronger than commonly believed.” Lewellen found that price reversals—that is, returns in one period being negatively correlated to returns in the preceding period—were most reliable when looking at one-year time periods, and these reversals were economically significant. Lewellen also found that mean reversion appears strongest in larger stocks.

Lewellen's work, when coupled with the work of other researchers, seems to give support to the idea that certain stocks show characteristics of mean reversion over certain periods of time. This mean reversion occurs primarily as a result of investor behavior that cannot be readily explained by the efficient market theory. In fact, it is becoming more apparent and, indeed, more accepted that investors do not always act rationally, that certain decisions, at least in the short term, are driven by psychology and emotion rather than logic. Under such circumstances, opportunities arise for the contrarian investor to take advantage of these short-term inefficiencies.

There is therefore a need for an investment strategy that takes into account these concepts and enables an investor to identify stocks which have a tendency to revert to their mean within a relatively predictable time period.

### SUMMARY OF THE INVENTION

The present invention is related to a system and method of investing in a market, which may be defined as a place where tangible or intangible goods or services are offered for sale. In particular, the present invention is related to a system and method of investing in a stable value item of trade in a market having a relatively stable value over a predetermined period of time and which has recently demonstrated a deviation from that stable value to an altered value, referred to herein as an altered value item of trade.

The exemplary embodiment includes a method of investing in an equity market. A disclosed method includes identifying a plurality of stable securities in the market. The trading level of each of the stable securities indicates an ability to substantially resist a negative change in the market in relation to other securities in the market over a predetermined time period. The method also includes identifying at least one most altered value security from the plurality of stable value securities having a current trading level that is substantially different than an average trading level of that stable value security. The method further includes determining an amount of money to be used to purchase an interest in the altered values security and buying that interest in at least one most altered-performing security. Finally, the method includes selling the interest in the most altered-performing stable security after a predetermined holding time period.

Other exemplary embodiments include buying stocks that are components of the Dow Jones Industrial Average showing the greatest percentage price decline for the year based on the premise that the losers in the market one year become winners the next. Therefore, one aspect of the investment strategy includes buying the worst-performing stocks in terms of percentage price change over the last twelve months in the Dow Jones Industrial Average. Preferably, the investor purchases a portfolio of the worst performers, such as the five worst performers, holds the stocks for a predetermined period of time (twelve months) and later rebalances the portfolio to include a new set of worst performers. This process then repeats for as long as the investment strategy is implemented.

In other exemplary embodiments, an investment strategy uses stock options and exchange-traded funds instead of common stocks to create the portfolios. Alternatively, the investment strategy can include the use of a ratio of stock price to two-hundred day moving average price of that stock (instead of the twelve-month price change) in order to determine the most altered value item of trade.

Under an embodiment, the market includes stock markets such as the New York Stock Exchange (NYSE), the National Association of Securities Dealers Automated Quotation System (NASDAQ) and the American Stock Exchange (AMEX), in which the items of trade include securities such as common stock, bonds, etc. One aspect of the disclosure is directed toward components of an index or index composite of a market such as the stocks in the Dow Jones Industrial Average. The average trading level or stable value of an item of trade includes the average price of the item of trade such as a price per share of common stock over a predetermined time period (e.g., twelve months or two-hundred days). The current trading level or altered value of an item of trade can include the price of the item of trade such as a price per share of common stock after that predetermined time period has expired.

In one exemplary embodiment, the stable value items of trade include stocks in an index. The stable value items of trade demonstrating a substantial deviation from their stable value relative to any deviation in value or altered value of the other identified stable value items of trade are considered for investment. The stable value items of trade are compared to one another to determine the stable items of trade that have an altered value that is substantially different than the other stable value items of trade. The comparison is based on data such as percentage change in value at distinct points in time separated by a predetermined period of time (e.g. twelve months) or in the average price per share over a predetermined period of time (e.g., two hundred trading days). The value can be represented by the price per share of common stock, a price per option to sell or purchase a certain number of shares of common stock within a particular time period, or any other suitable valuation of an interest in the item being traded.

Under the embodiment, the current trading level or altered value of the item of trade can be above or below the average trading level or stable value of the altered value item of trade. The method can include identifying a plurality of most altered value securities, in which the difference between the current trading level or the altered value of the item of trade and the average trading level or stable value of the item of trade identified as the most altered value item of trade can be greater than the difference between such trading levels or values of the identified plurality of stable value items of trade.

The investment or amount of money to be used to purchase an interest in the identified altered value items of trade includes dividing the amount of money in relatively equal portions between the identified items of trade. The investment can be divided among the identified altered value items of trade based on the extent to which the altered value is different from the stable value of the item of trade in relation to the other identified altered value items of trade. The greater the deviation from its stable value, the greater the portion of the investment allocated to that altered value item of trade.

Under an alternate embodiment, the interest in the altered value item of trade includes the right to buy or sell the item of trade such as derivative securities including options, long-term options futures, etc. The interest in the altered value item of trade can include at least one option to buy or sell at least one share of common stock at a predetermined price per share within a predetermined expiration time period. The expiration period can correspond with the predetermined holding time period of the invention.

The predetermined holding time period may also be based on optimizing the tax treatment of any gain or loss from the sale of the interest and can include a period of twelve months and one trading day. Alternatively, the method can include selling the interest in the most altered value security if the current trading level or altered value reaches a predetermined price per share.

The investment method of the present invention can be implemented on a processor, data network, website or any other suitable communication medium. A website or computer database can provide the user statistics on the performance of one implemented method as well as the information necessary to implement the method of the present invention.

### BRIEF DESCRIPTION OF THE FIGURES

FIG. 1 is a flow diagram illustrating the steps of an investment method of one embodiment of the present invention;

FIG. 1A is a flow diagram illustrating additional steps of an investment method of one embodiment of the present invention;

FIG. 2 is a table illustrating an exemplary performance in 2002 of stock components of the Dow Jones Industrial Average used in the investment method of one embodiment of the present invention;

FIG. 3 is a table illustrating an exemplary performance in 2002 of stock components of the Dow Jones Industrial Average used in the investment method of one embodiment of the present invention; and

FIG. 4 is a table illustrating an exemplary performance in 2003 of stock components of the Dow Jones Industrial Average used in the investment method of one embodiment of the present invention.

### DETAILED DESCRIPTION OF THE INVENTION

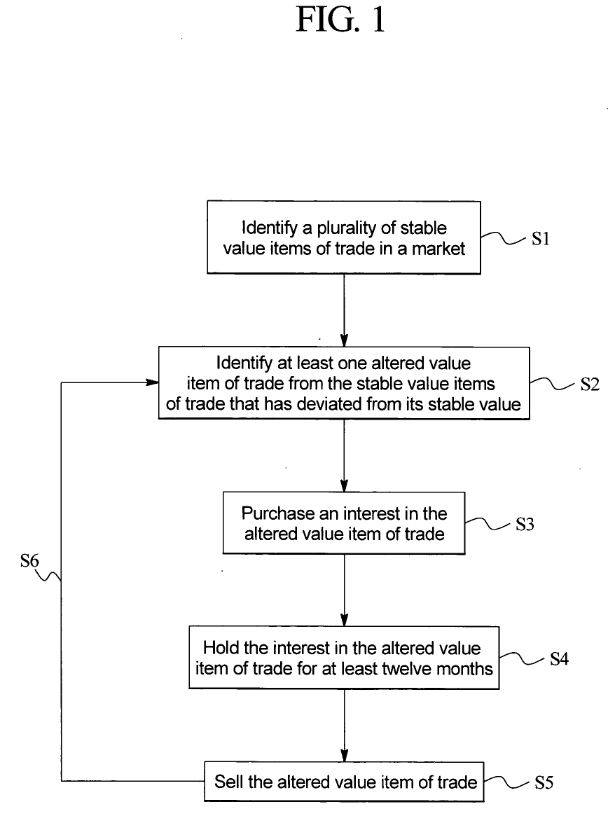

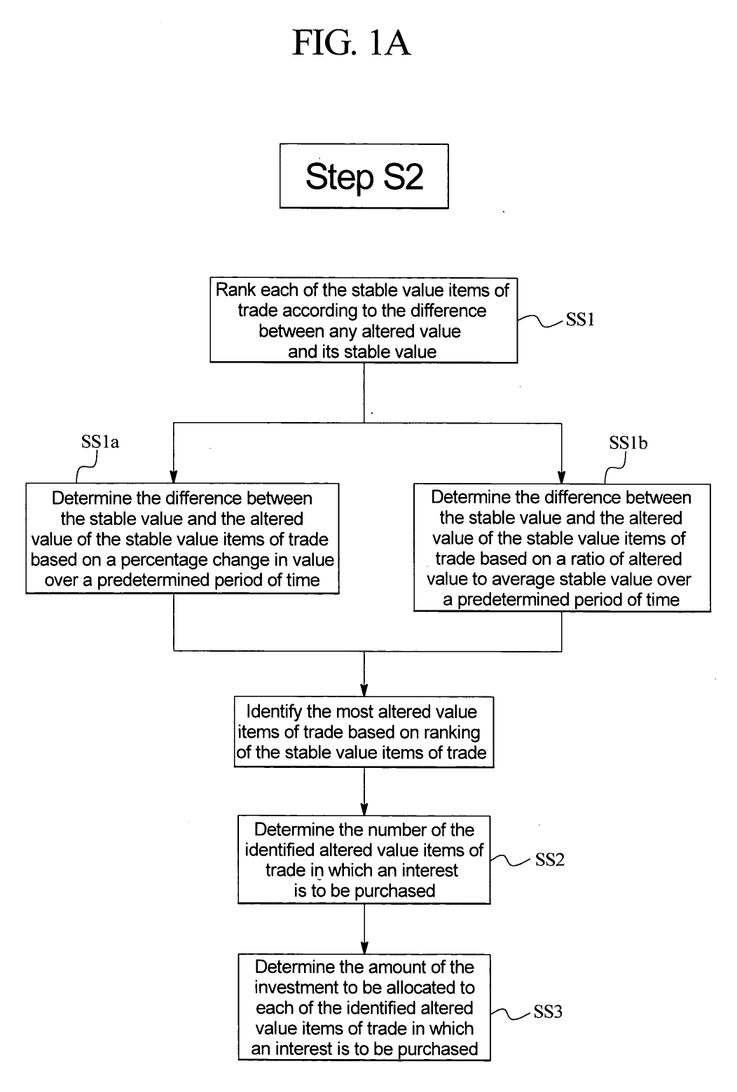

Referring to the drawings, FIG. 1 illustrates one embodiment of the present invention that includes a method for investing in a market. The steps of this embodiment include a first step S1 of identifying at least one stable value item of trade in a market. A second step S2 includes identifying from the previously identified stable value item of trade in step S1 at least one altered value item of trade with a value that has deviated substantially from its stable value over a predetermined period of time. A third step S3 includes purchasing an interest in the altered value item of trade identified in the second step S2. A fourth step S4 includes holding the interest in the identified altered value item of trade for a predetermined holding period of time at least twelve months. A fifth step S5 includes selling that interest at the end of the holding time period. A sixth step S6 includes identifying at least one altered value item of trade that has deviated substantially from its stable value over the holding period of time. It should be appreciated that steps S2 to S6 form a cycle that can repeat indefinitely.

The first step S1 of the investment method includes identifying at least one item of trade such as stocks, options, or any other items traded in a market having a substantially stable value. A substantially stable value demonstrates a high level of stability such that any deviation in the value of the item of trade or altered value has a tendency to revert to a mean or stable value. In other words, the value of the item of trade is so well established that a return to a stable value following a deviation from that stable value is reliably predictable.

The investment method of the invention is preferably applied to items of trade such as stocks that have a calculated value that demonstrates long-term stability or equilibrium and have characteristics that indicate that the stock will survive changes in the economy and the market so that a short-term deviation from an equilibrium will eventually result in reversion to that stable value mean stock price. Stocks that are so stable that their price tends to indicate trends in trading in a market as a whole are often candidates for an index of activity of the market. Therefore, one embodiment of the invention includes identifying stocks used in an index of a market as candidates for investment.

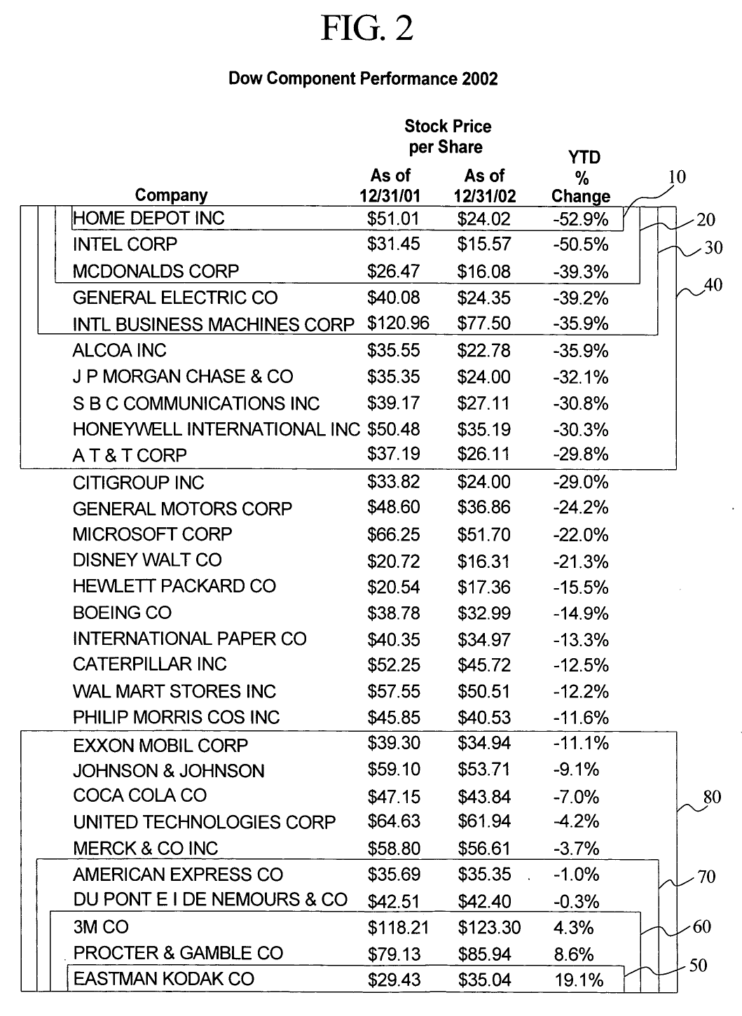

One group of companies whose stock is characterized by this level of consistency and predictability includes the companies listed on the Dow Jones Industrial Average (DJIA). Therefore, it is highly probable that a short-term deviation of a stock listed on the DJIA from an equilibrium will eventually result in reversion to the mean stock price. In the example illustrated in FIGS. 2 to 4 below, one aspect of the disclosed method includes identifying the components of the DJIA in which to invest. Stocks chosen to be included among the thirty components of the DJIA are typically stocks that have an excellent reputation, demonstrate sustainable growth, are of interest to a large number of investors, and accurately represent the sector(s) covered by the DJIA. The DJIA, in particular, serves as a measure of the entire U.S. market and is not limited to traditionally defined industrial stocks. Because continuity of gauging market trends is important, composition changes to the DJIA listings are rare. In fact, changes typically occur only after corporate acquisitions or other dramatic shifts in the core business of the component. It should be appreciated that other indexes or groups of stocks selected for their stability in other markets, market sectors, or industries may also be chosen for application of the system and method of the present invention including the S&P 500, NASDAQ Composite, Dow Jones Utility Average, Dow Jones Transportation Average, and Dow Jones Global Titans Index, among others.

The thirty stocks comprising the Dow Jones Industrial Average as of Nov. 10, 2003, incorporated in the examples illustrated in the figures and their stock symbols are provided below along with the exchanges where the stocks are listed (NYSE—New York Stock Exchange; NASDAQ—Nasdaq Market):

| | | |
|---|---|---|
| AT&T (NYSE: T) | Eastman Kodak (NYSE: EK) | Johnson & Johnson (NYSE: JNJ) |
| Alcoa (NYSE: AA) | Exxon Mobil (NYSE: XOM) | JP Morgan Chase (NYSE: JPM) |
| Altria Group (NYSE: MO) | General Electric (NYSE: GE) | McDonalds (NYSE: MCD) |
| American Express (NYSE: AXP) | General Motors (NYSE: GM) | Merck & Co. (NYSE: MRK) |
| Boeing (NYSE: BA) | Hewlett-Packard (NYSE: HPQ) | Microsoft (NASDAQ: MSFT) |
| Caterpillar (NYSE: CAT) | Home Depot (NYSE: HD) | Procter & Gamble (NYSE: PG) |
| Citigroup (NYSE: C) | Honeywell International (NYSE: HON) | SBC Communications (NYSE: SBC) |
| Coca-Cola (NYSE: KO) | International Business Machines (NYSE: IBM) | 3M (NYSE: MMM) |
| Disney (NYSE: DIS) | Intel (NASDAQ: INTC) | United Technologies (NYSE: UTX) |
| DuPont (NYSE: DD) | International Paper (NYSE: IP) | Wal-Mart Stores (NYSE: WMT) |

In addition to having a reputation of stability, the current DJIA components are readily available and listed daily in periodicals such as The Wall Street Journal and on various well-known websites such as www.dowjones.com. Other information on the components of the DJIA, such as its twelve-month price change and two-hundred day moving average, are also available in periodicals and on websites. These sources provide information or data upon which an exemplary method is implemented. The information may include lists making the performance of the items of trade over a predetermined period of time such as for the previous year. It should be appreciated that, when determining stock price, the investor must take into account any corporate actions such as dividends, stock splits, spin-offs, etc. that will affect the stock price.

Still referring to FIG. 1, step S2 calculates which of the stable value items of trade have deviated the most from their mean or average stable value. As illustrated in FIG. 1A, step S2 includes sub-step SS1 of ranking the stable value items of trade according to the deviation of the altered value from the stable value in each of the stable value items of trade. The deviation can be determined by sub-step SS1a of calculating the difference between the stable value and the altered value of the items of trade based on a difference in value at two points in time, such as a percentage change in value over a predetermined period of time. Alternately, sub-step SS1b calculates the difference between the stable value and the altered value of the items of trade based on an average value over a period of time such as a ratio of altered value to average stable value over a predetermined period of time. Step S2 can also include sub-step SS2 of calculating how many altered value items of trade and sub-step SS3 of calculating what amount of the investment will be allocated to each of those altered value items of trade.

The investor chooses the altered value items of trade based on an altered value that differs from its stable value more than any other stable value item of trade. For example, the group of altered value items of trade can include the worst-performing stocks in a group of stocks such as DJIA. On the first trading day of the new year, the investor uploads or enters the components of the DJIA according to their percentage change in stock price from the price per share a year ago, and the price per share. FIG. 2 illustrates the percentage change in the stock price per share of each component of the DJIA from Dec. 31, 2001. The investor then identifies the five worst-performing stocks based on their twelve-month percentage price change.

To implement step S2, a worksheet can be created. The worksheet lists the item of trade and a basis upon which to compare any difference between the stable value and altered value such as the twelve-month percentage price change. Under the illustration of FIG. 2, the worksheet comprises a two-column list, although step S2 may also include sub-step SS1 of ranking the stable value items of trade according to the deviation of the altered value from the stable value in each of the stable value items of trade. The invention may also include sub-step SS1a of determining the difference between the stable value and the altered value of the items of trade based on a percentage change in value over a predetermined period of time. FIG. 2 also illustrates ranking the DJIA stocks according to a measure of their performance or average trading level over a period of time. As an example, the stocks in FIG. 2 are listed in order of the worst performer for calendar year 2002 to the best performer of calendar year 2002 based on the twelve-month percent price change for each stock. It should be appreciated that the most altered value item of trade can be the best performer of the best-performing DJIA stocks or the worst performer of the worst-performing DJIA stocks.

In FIG. 2, a worksheet is created which lists in two columns the company name and the twelve-month percentage price change. To determine the percentage change of a stock price, the difference between a stable value and altered value of a stock over the predetermined period of twelve months is calculated. Accordingly, the start price or the presumed stable value of the stock is subtracted from the end price or the altered value of the stock. The difference is divided by the start price. For example, the stock price for Home Depot on the start date, Dec. 31, 2001, was $51.01 per share, and, on the end date, Dec. 31, 2002, Home Depot stock was selling for $24.02 per share. The difference between the start price and the end price ($24.02−$51.01=−$26.99) is then divided by the start price ($51.01). The percentage change is a decrease of 52.9 percent. This calculation is repeated for each DJIA stock.

Once the information is entered, the list is sorted from the worst-performing stock to the best-performing stock based on the twelve-month percentage price change. FIG. 2 includes a listing of the DJIA stocks as of the end of 2002, along with their twelve-month price changes. The stocks are ranked from worst performer to best performer. As illustrated in FIG. 2, the five-worst-performing stocks in 2002 based on the change in stock price over a twelve-month period include Home Depot at −52.9%, Intel at −50.5%, McDonalds at −39.3%, General Electric at −39.2% and International Business Machines at −35.9%. The best-performing DJIA stock includes Eastman Kodak (+19%).

Alternately, Step S2 of the invention may include the sub-step SS1b—determining the difference between the stable value and the altered value of the items of trade based on a ratio of altered value to average stable value over a predetermined period of time. Specifically, an investor may use a two-hundred day moving average of a stock to determine which component demonstrated the greatest difference between its altered value and stable value or deviation from its mean or average. The potential problem with simply using percentage price change to determine the worst-performing stocks ripe for mean reversion is that the worst performers may actually not be trading well below their long-run average. For example, in 1994, Woolworth was the worst-performing stock in the DJIA. Based on the present invention, we would expect Woolworth to have performed well in 1995. What happened? Actually, Woolworth had a poor year in 1995, finishing down 13%. For comparison, the DJIA posted a return of +36% in 1995. What went wrong? One explanation is that, perhaps Woolworth, despite its poor performance (the stock was down 41%), had not reached an extreme level below its long-run average price and thus was not due to revert in 1995. But how would one determine this?

In one embodiment, a stock's equilibrium range is determined by calculating a stock's average trading level over some period of time. A time frame over which evaluating stocks includes, for example, is a two-hundred day moving average. The two-hundred day moving average is calculated by calculating the average price of the stock over the last two hundred trading days. Additional averages are computed over a two-hundred trading day period by adding a day and dropping a day from the two hundred trading days. The stock's two-hundred day moving average line takes into account a fairly long period of stock prices and, therefore, represents a worthwhile benchmark for the long-term equilibrium trading level of a stock—the stable value of the stock. When the stock is trading well above or well below that stable value represented by the two-hundred-day moving average, the stock eventually migrates back to its long-term equilibrium level. Thus, an alternative way to employ the method of the present invention includes buying the DJIA stocks trading the greatest percentage below their two-hundred day moving average. In that way, an investor purchases an interest in the stocks that, according to mean reversion, should demonstrate significant rebounds.

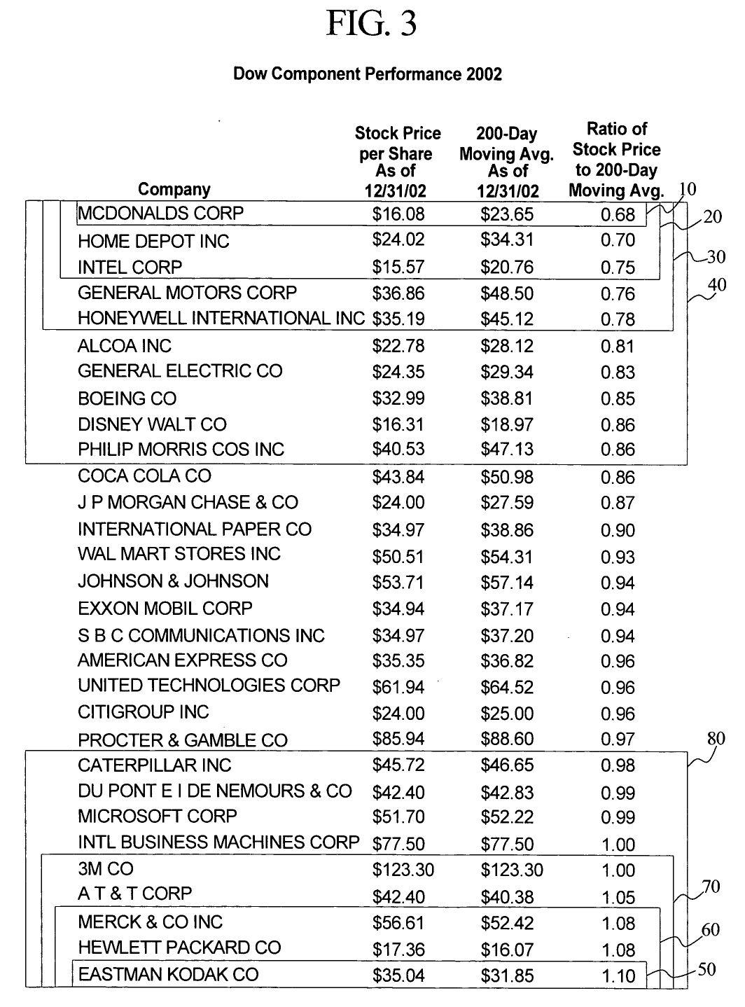

Turning to FIG. 3, stocks of the DJIA are ranked from worst to best performance based on the ratio of current stock price to the two-hundred day moving average price of the stock on the last trading day of 2002. FIG. 3 illustrates DJIA stocks as of the end of 2002, along with the ratio of the stock's year-end price to its two-hundred day moving average. It should be appreciated that that the smaller the ratio, the greater the stock is trading below its two-hundred day moving average. As of Dec. 31, 2002, for example, McDonalds was the worst-performing stock of the DJIA stocks trading at only 68% of its two-hundred day moving average. Therefore, identifying the most altered value items of trade yields the following five worst-performing stocks of the DJIA during 2002 based on the deviation of the stocks from their two-hundred day moving average: McDonalds, Home Depot, Intel, General Motors and Honeywell.

It should be appreciated that the ranking of a group of stocks based on the deviation of the stocks from their two-hundred day moving average may not necessarily correspond to their ranking based on their twelve-month percent price change. For example, although McDonalds was the worst-performing stock based on its deviation from its two-hundred day moving average, its performance was better than Home Depot and Intel based on its twelve-month percent price change. In many cases, however, the worst-performing stock will also be the stock trading the most below its two-hundred day moving average. As illustrated in FIGS. 2 and 3, six of the worst-performing stocks in terms of their twelve-month percent price change are also among the worst performers in terms of their two-hundred day moving average.

In one embodiment, at least one most altered value item of trade is identified by its deviation from its stable value as measured by a combination of its twelve-month percentage price change and the ratio of its stock price to its two-hundred day moving average. For example, in FIG. 2, the five worst-performing stocks for calendar year 2002 based on their twelve-month percent price change are Home Depot, Intel, McDonalds General Electric and IBM. In FIG. 3, the five worst-performing stocks for calendar year 2002, according to their ratio of stock price to two-hundred day moving average was McDonalds, Home Depot, Intel, General Motors and Honeywell. If the investor continues to proceed down each list of FIGS. 2 and 3 to determine which stocks are worst-performing under both measures of performance, a five-stock portfolio of Home Depot, Intel, McDonalds, Alcoa and General Electric is compiled. Such a portfolio generated a return of 60.4% for 2003 compared to a 51% return on a five-stock portfolio based on twelve month percent change. Similarly, a ten-stock portfolio including Home Depot, Intel, McDonalds, General Electric, Alcoa, JP Morgan, Honeywell, General Motors, Disney and Boeing achieved a return of 47% for 2003 compared to a 34% return on a ten-stock portfolio based on twelve month percent change.

It should be appreciated that one may improve the odds of investing in stocks that are ready to rebound by incorporating the two-hundred day moving average analysis into the investment strategy of the present invention. Evaluating the performance of a stock based on a value over a period of time, such as its two-hundred day moving average, can confirm that a stock that is determined to have the most altered value in terms of a difference in value at two points in time, such as the twelve-month percentage price change, is truly altered from its equilibrium price range.

Whether the investor uses a twelve-month percent price change, two-hundred day moving average, any other suitable form of measuring the average trading level of a stock over a period of time or combinations thereof, the invention includes calculating a benchmark against which the performance or altered value of the stocks in the group of stable stocks is evaluated. It should be appreciated that other methods of identifying an altered value item of trade are contemplated by the present invention. For example, a long-term equilibrium level or stable value of an item of trade can be evaluated over other time periods such as a moving average of at least one to two years. Alternatively, since there are approximately 252 trading days per year, one may consider a 252-day moving average or 500-day moving average. One advantage of using a two-hundred day moving average is that it represents a fairly lengthy period of time and it is readily obtainable as discussed above.

Sub-step SS2 of step S2 which identifies the altered value items of trade to be purchased includes determining the number of altered value items of trade to include in the investment portfolio as illustrated in FIG. 1A. Under either example of ranking the DJIA stocks as illustrated in FIGS. 2 and 3, the investor can include the worst-performing stock 10, the three worst-performing stocks 20, the five worst-performing stocks 30 or the ten worst-performing stocks 40. Alternatively, the investor can include the best performing stock 50, the three best-performing stocks 60, the five best-performing stocks 70 or the ten best-performing stocks 80.

The investor may choose any number of items of trade which demonstrate the greatest deviation from their stable values. It should be appreciated, however, that the fewer stocks one holds, the greater the volatility of the portfolio. Indeed, a single-stock portfolio may experience huge volatility as a result of stock-specific risk. Also, if the company is trading below its equilibrium level because it is in financial distress, there is no assurance that mean reversion will kick in if finances go from bad to worse. A portfolio including the five or ten worst performers tends to be more risk averse than a one-stock portfolio. A portfolio, for example, which includes five stocks is large enough to reduce portfolio volatility, yet small enough to maximize the power of the investment method. The more stocks an investor includes in the strategy, the more the total portfolio migrates toward the average performance of the stable stocks from which the most altered-performing stocks are selected. Thus, the investment method includes placing a protective “stop” order, if the stock that is trading the greatest percentage below its equilibrium level is the only stock in the portfolio. The “stop” order automatically sells the stock if its market value reaches a predetermined price and helps to protect the downside risk. For example, buying $5,000 worth of Home Depot stock, the worst-performing stock during the previous year based on twelve-month percent price change, the stock is purchased at $24.02 (the closing price of 2002) and a stop order is set at $20.40 or 15% below the market price in order to protect the downside risk. This establishes a long position in Home Depot.

Under another exemplary embodiment, a number of altered value items of trade to be purchased are calculated and included in a portfolio based on the number of altered value items of trade that have reached extreme price levels on the downside or upside relative to other stable stocks. To this end, the investment strategy of the present invention is not directed to average performers in the market. Rather, the present invention is directed to terrible performers such as stocks whose performance is substantially below that of the average performers in the market. Requiring a substantial deviation between a stable value and an altered value is likely to achieve the type of spread that enhances returns as reversion to the mean occurs. The performance of the ten worst-performing DJIA stock, for example, may not be all that different from the performance of the ten best-performing DJIA stocks. It is highly likely that a portfolio with average performance will achieve a near average return in that particular year. For example, among the DJIA components in calendar year 2002, Home Depot at −52.9% change and Intel at −50.5% change from the previous year have reached extreme difference in price compared to the overall performance of the DJIA components. Similarly, Eastman Kodak demonstrated an upside extreme of +19.1% of its price a year ago.

Once the investor chooses the stocks in which to invest, sub-step SS3 of step S2 calculates an amount of money to be invested in the stocks as illustrated in FIG. 1A above. The amount to be invested can be based on the amount of money the investor has to invest, the specific percentage of a portfolio that focuses on the investment strategy of the present invention, or any other suitable method of determining an amount to be invested in the investment method. It should be appreciated that the capital requirements of the investment method are such that virtually any investor, regardless of the size of the portfolio, should be able to invest money in the approach. Moreover, the ability to adapt investment vehicles to purchase interests in items of trade such as options and LEAPS that require less initial capital commitment to the overall investment strategy further enables the opportunity to invest with this method.

For example, to implement the investment method, on the first day of trading in 2003, the investor determines which value items of trade in which to invest for the next holding period of time. In this example, the investor decides to invest $10,000. A one-stock portfolio is set up in which all of the investment is put into an altered value item of trade. The altered value item of trade can be an item of trade having the most altered value or one of the most altered value during a certain period of time such as Home Depot, which was the worst-performing stock in the DJIA in 2002. In one embodiment, the three-stock portfolio is set up in which the investment is divided between the three worst-performing stocks in the DJIA in 2002 or $3,333 worth of each of the following stocks—Home Depot, Intel, and McDonalds. In a preferred embodiment, the investment is divided between the five worst-performing stocks in the DJIA in 2002 or $2,000 worth of each of the following stocks—Home Depot, Intel, McDonalds, General Electric, and IBM,. It should be appreciated that any number of the DJIA stocks can be chosen.

Continuing with the example, the portfolios of the investment method are equally weighted from year to year. In other words, the amount invested is kept relatively equal among the stocks purchased. Thus, if an investor determines that $10,000 will be invested in five of the worst performing stocks in 2002 based on the twelve-month percentage price change, the investor will purchase $2,000 of Home Depot stock at $24.02 per share or 83.3 shares, $2,000 of Intel stock at $15.57 per share or 128.5 shares, $2,000 of McDonalds stock at $16.08 per share or 124.4 shares, $2,000 of General Electric at 24.35 per share or 82.1 shares, and $2,000 of International Business Mechanics at $77.50 per share or 25.8 shares. It should be appreciated that it is highly unlikely that all five stocks will be trading at the exact same price; therefore, $2,000 will buy different share amounts.

Alternatively, the investor invests an amount proportional to the deviation of the altered value item of trade from its stable value. Hence, the investment method includes investing a greater portion of the investment amount in altered value items of trade having a greater deviation from their stable value or average level of trading. For example, compared to the other four stocks in a five-stock portfolio, Home Depot represents 24% (52.9%/(52.9+50.5%+39.3%+39.2%+35.9%) of the collective deviation of the most altered-performing securities—the collective deviation is 218% (52.9%+50.5%+39.3%+39.2%+35.9%). Therefore, of a $10,000 investment instead of investing $2,000 in each of the five stocks in the portfolio the investor invests $2,400 in Home Depot. Similarly, Intel represents 23%, McDonalds 18%, General Electric 18%, and IBM 17% of the collective deviation of the most altered-performing securities. Accordingly, the investor invests $2,300 in Intel, $1,800 in McDonalds, $1,800 in General Electric, and $1,700 in IBM. It should be appreciated that other suitable methods of distributing the investment amount between more than one altered value item of trade may be used.

As discussed above, the investment method includes equally weighting the portfolios from year to year. Many of the indexes, including the DJIA, however, are price-weighted indexes; that is, higher priced stocks carry the greatest weight in the index. For example, a 10% advance in an $80 stock has a much greater impact on the overall index average than a 10% advance in a $20 stock. Therefore, an investment strategy that includes equal weighting in conjunction with selecting low-priced stocks that are ready to revert to the mean stands a high chance of outperforming a price-weighted benchmark, such as the DJIA. In other words, the best way to beat a price-weighted index like the DJIA is to choose low-priced stocks that are likely to revert to the mean and equal weight those stocks in a portfolio.

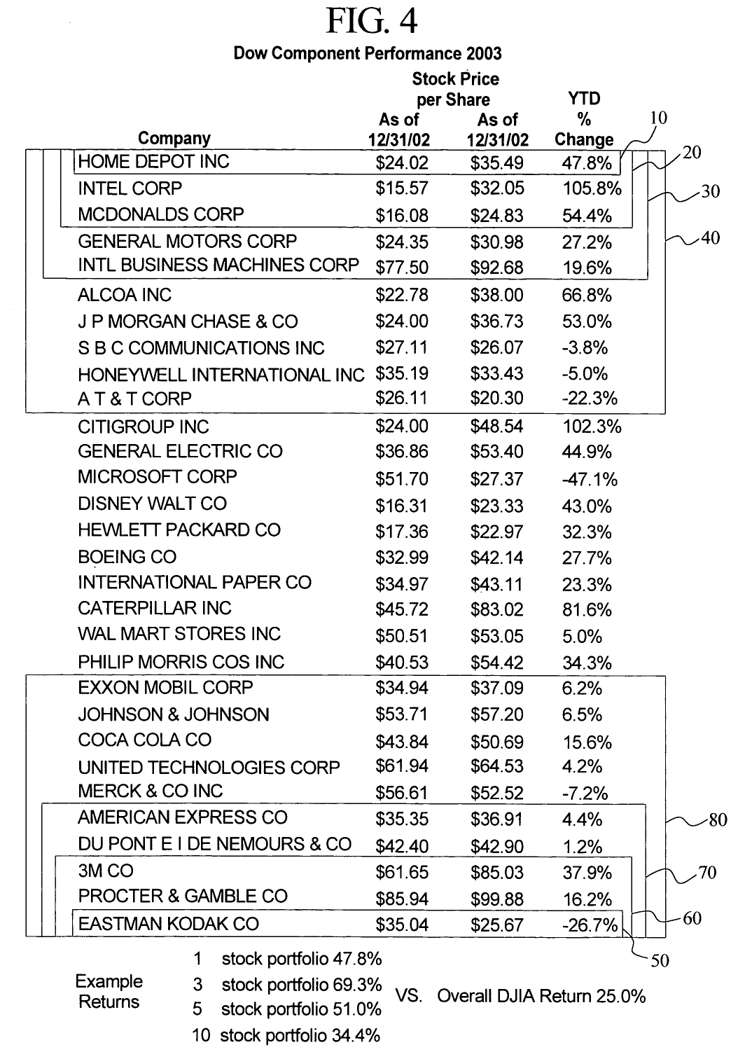

Accordingly, in one embodiment, an altered value item of trade is chosen based on its altered value. Once a group of altered value items of trade has been identified from the stable value items of trade based on percentage change in value over a predetermined period of time or a moving average value over a predetermined period of time, the investment method includes purchasing an interest in one or more altered value items of trade with the most altered value. For example, an investor can choose to invest in the five lowest-priced DJIA stocks from the group of the ten worst-performing DJIA stocks based on their percentage price change, 200-day moving average or both. The investment method, then, includes investing a substantially equivalent amount in each of the chosen stocks. This would mean that, according to FIG. 2, an investment of $10,000 in a five-stock portfolio would include an investment of $2,000 in each of the lowest priced stocks of the ten worst-performing stocks 40 of 2002—Intel at $15.57 per share, McDonalds at $16.08 per share, Alcoa at $22.78 per share, JP Morgan at $24.00 per share and Home Depot at $24.02 per share. As can be determined from the data illustrated in FIG. 4, the $10,000 investment using this method would grow to $16,310 in 2003 or a 63.1% return to the investor. In addition or alternatively, the investor can choose to short the five highest-priced DJIA stocks from the list of the ten best-performing DJIA stocks based on their percentage price change, 200-day moving average or both.

Referring back to FIG. 1, upon identifying the altered value items of trade in which to invest and the amount to be invested in the item of trade, the next step S3 of the investment method of the invention includes purchasing an interest in the altered item of trade. The investor can purchase the interest through a broker or brokerage account, or any other suitable mechanism for trading in the particular market. An advantage of the present invention is that an investor does not need advice or research services; the investment method determines all of the buy and sell decisions. Not needing these additional services saves the costs of a full-service broker that may, otherwise be needed.

In one embodiment, the investment method is implemented on the first day of the year. Alternatively, an investor implements the method anytime throughout the year if the investor can determine which stable value items of trade have demonstrated the largest percentage price change over a predetermined period of time such as the last twelve months, are trading at the great percentage change below a moving average or are otherwise demonstrating a deviation from the stable value of the item of trade.

Under an exemplary embodiment, the inventor purchases a plurality of shares of common stock. Trading orders used to buy the stock include a market order or a limit order. In one embodiment of the present invention, the investor uses a “market order” to purchase the stock. A market order will buy stock at the prevailing market price. The market price includes two prices, a “bid” price and an “ask” price. The bid price represents the price one will receive if one sells a share of a stock at the market price. The ask price is the price one will pay if one buys a share of a stock at the market price. The difference between the bid and ask price is termed the “spread”. The spread is provided to the broker and/or market maker. The spread is affected by trading volume; that is, stocks that do not trade often, such as stocks of smaller companies, usually have large spreads. Indeed, it is not uncommon for small companies to have spreads of $1 or more per share.

Alternatively, the investor purchases the stock by placing a “limit” order. A limit order specifies the exact price at- which one is willing to buy the stock. Because of such large spreads between an asking price and a bidding price in stocks of smaller companies, the best way to purchase stocks of smaller companies is by placing a limit order. For example, if an investor wants to buy a stock with a bid price of $10 and an ask price of $11 per share, if a market order is placed, the investor will probably pay around $11 (or worse if the market is moving) if a market order is placed, thus building in a loss of about $1 per share. If an investor buys this stock and immediately sells it, the investor would buy at the ask price of $11, and sell at the bid price of $10, thus locking up a $1 loss per share. Instead of paying such a large spread, the investor can place a “limit” order with the broker instructing the broker to buy only if the stock falls to a particular price, such as $10.25 per share. The problem with placing a limit order is that there is no guarantee one will ever buy the stock. Indeed, the stock could jump sharply and never look back leaving the investor without the opportunity to own a big gainer by trying to save a relatively small amount. Furthermore, because one embodiment of the investment strategy of the present invention focuses on large, highly liquid DJIA stocks, the spreads between the bid and ask price are usually very, very small. Thus, it is preferable to place market orders when buying such stocks to ensure the purchase of the stock.

In alternative embodiments, the investor purchases the right to sell an item of trade at a particular price, otherwise known as “selling short” or “shorting” if the item of trade is stock. For example, a short seller sells a stock he does not actually own with the hope of buying back the stock at a lower price, thus pocketing the difference in price. It should be understood that reversion to the mean applies not only to items of trade that have an altered value that has fallen and are due to rebound, but also items of trade that have an altered value that has surged in value and, under mean reversion, are expected to pull back to their long-term equilibrium range or stable value. Accordingly, an investor who feels comfortable “shorting” stocks can also take advantage of mean reversion.

Employing short selling in the present invention includes identifying an altered value item of trade that has an altered value above its stable value. For example, if the investor believes International Paper, which is trading at $40 per share, is overvalued at current prices and is headed lower, he can sell shares of International Paper that he does not own. By selling the stock, the short seller locks up a $40 per share sale price. At some point, the short seller must “close out” his position, which means he must buy back the stock in the future. If, as predicted, the stock value declines to $25 for example, the short seller can then close out the position by buying back the International Paper stock at $25. In this scenario, the short seller makes $15 per share in profit (sold at $40, bought back at $25 for a $15 difference), minus trading commissions.

This example shows what can happen when short selling works to the advantage of the investor. Short selling can, however, expose the investor to losses. For example, if the investor is wrong about International Paper, and the stock surges to $60, the investor shows an unrealized loss of $20 per share on the holding. The short seller would not necessarily have to close out the position by buying back the stock, however, the short seller will probably have to invest more money to cover the “margin” or the collateral (cash and or stocks in the brokerage account) that one must have with a broker in order to sell short.

Shorting stock carries a significant risk leading to big losses because the loss potential is unlimited. When an investor buys stock, the loss potential is the amount of the investment. When an investor shorts a stock, however, the losses are unlimited since the stock can (in theory at least) rise to infinity. However, an investor can set stop orders in short positions, as well as long positions as discussed above. Thus, one way to reduce the downside risk in short positions is to set a protective stop above the purchase price of the short position is placed to limit the risk. For example, selling short $5,000 worth of Eastman Kodak—the best-performing stock during the previous year based on the twelve-month percent price change—the stock is purchased at $35 and a stop order set on the short at $40.25 or 15% above the purchase price.

Under yet another alternative embodiment, an investment method includes taking advantage of the concept of mean reversion as applied'to both the worst-performing stocks and the best-performing stocks. Here, the investor method includes implementing what is referred to herein as a “long-short” method. In this method, the investment method includes purchasing an interest in at least one altered value item of trade that has the greatest percentage below its stable value. At the same time, the investment method includes selling short at least one altered value item of trade that has the most altered value and is trading the greatest percentage above its stable value.

As an example, the investing method is implemented by buying the worst-performing DJIA stock in 2002 based on percentage price change over twelve months (in this case, Home Depot) while shorting the best-performing DJIA stock in 2002 (in this case, Eastman Kodak) with the anticipation that Home Depot stock prices will rise to its equilibrium level or more and Eastman Kodak will decline to its equilibrium level or less. If such occurs, the investor makes a profit on the long position (Home Depot) while generating a profit on the short position (Eastman Kodak). At the very least, in order to generate a profit on the trade, Home Depot must rise more than Eastman Kodak or vice-versa. In that way, the long position covers the losses on the short position in Eastman Kodak or vice-versa. Under the example embodiment, the long position in Home Depot and the short position in Eastern Kodak is held for one year and one day, although other suitable periods of time may be used. At the end of the holding period according to the investment method, the Home Depot position is sold while the short position in Eastman Kodak is bought back or “covered.”

A variation of the “long-short” investment method includes buying the five worst-performing DJIA stocks while going short on the five best-performing DJIA stocks. Alternatively, an investor can go long on the DJIA stock that is trading the greatest percentage below its two-hundred day moving average while shorting the DJIA stock trading the greatest percentage above its two-hundred day moving average.

The investment method includes purchasing interests in altered value items of trade other than an ownership interest in the item of trade itself. In one embodiment, futures and options are employed in the investment method. Two types of options include an option to purchase the altered value item of trade at a particular within a certain period of time, a “call”, or an option to sell the altered value item of trade, a “put”, at a particular price within a certain period of time. It should be appreciated that the investor can trade other interests or rights in an item of trade in a market for those interests and rights. All thirty DJIA stocks have call and put options available for purchase. Accordingly, an investor who wants to implement any variation of the strategy of the invention can do so using put and call options rather than or in addition to buying and shorting the underlying stocks.

In one example, one option gives the investor the right to purchase one hundred shares of an underlying stock. Purchasing options instead of the stock allows an investor, in addition to the increased leverage, to implement the method of the invention with less initial capital investment. To buy one hundred shares in each of the five stocks in 2003 would entail an investment of more than $15,700. However, to purchase an interest in the equivalent of one hundred shares in each of the companies through purchase of a single call option in each of the five companies (assuming one bought call options with a strike price that matched the current stock price) would have entailed a much smaller investment, as low as $1,000 if one purchased relatively short-term options (expiring within three months).

The price of an option includes a “premium” to obtain the option. Option premiums are determined by a variety of factors. An important driver of option premiums is the underlying volatility of the stock: the more volatile the stock, the higher the cost of the option premium. For example, if an investor pays $500 to purchase a call option in American Express at $40 per share, the investor becomes the owner of the right or option to purchase one hundred shares of American Express stock anytime over the next nine months at $40 per share. If the stock soars from $40 to $50 in four months, the value of each option is at least $10 per call option. If its value was less than $10, the investor exercises the options, buys American Express at $40, and immediately sells at $50 for a gain of at least $10 per share. Actually, the call option will be worth more than $10 since the premium will reflect the fact that there are still five months remaining before the option expires. In this scenario, the initial investment has at least doubled to $1,000. In other words, in just four months, the investment has gained 100% or more. Compare that gain to the gain had one bought the stock instead of the option. The gain in American Express stock would only be 25% (a $10 gain on a $40 purchase price), a good return for four months, but less than the gain on the call option. If an investor believes that American Express stock is overpriced at $40 per share and will drop to at least $30 over the next nine months, but is not comfortable selling short American Express, the investor may buy a “put” option to leverage this bet. As mentioned above, a put option gives an investor the right to sell a stock at a given price. If the investor purchases a put option on American Express with a strike price of $40 and with a nine-month life, that option gives the investor the right to sell American Express stock at $40 per share anytime during the next nine months. Again the investor pays an option premium of $500 for the put option.

If, instead of rising to $50 per share, American Express drops to $30, the value of the put option is worth at least $10. Again, the put option gives one the right to sell the stock at $40. However, investors cannot sell something they do not own. Therefore, the investor exercises the put option and sells the stock at $40 per share. To cover that sell, the investor buys back the stock and, in this case, would buy back the stock at $30 per share. Thus, the profit would be $10 (selling at $40 and buying at $30). As in the previous case, the value of the option doubled, from $500 to $1,000. Thus, the gain on the put options is 100%.

Options have a limited lifespan. The longer the life of the option, the greater its value as a result of the “time premium.” However, as time elapses and the option gets closer and closer to its expiration date, the time premium shrinks and eventually disappears. If, for example, an investor bought an American Express call option with a strike price at $40 and the stock trades for $39 at the end of the option's life, the option would expire worthless. That is because an option to buy a stock at $40 that is trading for $39 has no value at all. Therefore, an investor, has to be right about the direction of the underlying stock and has to see that idea come to fruition in a fairly limited period of time. It should be appreciated that being right about a stock and right about its timing is difficult to do successfully over time. Accordingly, to employ the investment strategy of the present invention on the first day of trading in 2003 buying options in the five worst performers in 2002, rather than stock, the investor purchases options on Home Depot at $24.02 per share, Intel at $15.57 per share, McDonalds at $16.08 per share, General Electric at $24.35 per share, and IBM at $77.50 per share.

Although most options have a maximum nine-month life, a form of option exists that provides investors with an option life of more than twelve months which is compatible with the preferred holding time period of the present invention. In one embodiment, the investment strategy of the invention includes purchasing options in an altered value item of trade that have a term of at least twelve months known as Long-Term Equity Anticipation Securities (“LEAPS”). LEAPS are long-term call and put options. LEAPS are purchased on the various options exchanges the same way and in the same dollar increments as call and put options and are available for all DJIA stocks. In one example, one LEAP call is the equivalent of having an option to buy one hundred shares of the underlying stock. One LEAP put is the equivalent of having an option to sell one hundred shares of an underlying stock. Like options, LEAP values reflect both a time premium as well as a price premium. Thus, the closer the LEAP is to expiration, the less the time premium in the LEAP price.

LEAPS are attractive vehicles for implementing an aggressive form of investment method of the present invention. First, LEAPS provide substantial leverage for investors. Since LEAPS are options, gains in the underlying stock will create even bigger percentage gains in the LEAP. Of course, losses in the underlying stock results in even greater losses, on a percentage basis, in the LEAP. Second, buying LEAPS is as easy as buying common stocks or call and put options with a margin account at a broker.

Any method employing stocks can be employed at a predetermined time period using LEAPS. For example, if an investor believes that the worst-performing DJIA stock will do well and the best-performing DJIA stock will decline, the investor can buy the LEAP call option on the worst performer and the LEAP put option on the best performer to simulate a “long-short” strategy. The investor can also combine LEAPS and stocks. For example, the investor can go long on the worst-performer by buying the stock while buying a LEAP put option on the best performer.

Under an exemplary embodiment, the investment strategy includes buying a LEAP that has a lifespan greater than twelve months. On the first day of each year, for example, the method of the invention can include purchasing LEAPS of the five most altered value items of trade over the last twelve months. Alternatively, the invention can include buying the LEAP of the most altered value items of trade that is trading the greatest percentage above or below its two-hundred day moving average. Like regular call and put options, LEAPS expire after the third Friday of the expiration month and the last trading day for the LEAP is the business day preceding that Saturday.

It should be appreciated that strategies employing options and LEAPS may not always be tax friendly relative to owning and holding the underlying stocks for more than twelve months. Indeed, all gains on traditional call and put options are taxed at ordinary income rates because they have a maximum life of nine months. Furthermore, the current tax rules governing LEAPS are complicated in terms of defining short-term and long-term gains.

In one embodiment, the invention is used to enhance an otherwise conservative portfolio. For example, the invention can enhance an investment in an index, such as in the Dow Jones Industrial Average, referred to herein as an enhanced index investment. An enhanced index investment attempts to generate superior returns to the index while not straying too far from the performance of the underlying index. One reason enhanced indexes are appealing to investors is that, on the one hand, an enhanced index investment is usually going to perform close to the underlying index. Thus, an investor who does not want too much variation in returns over time from a particularly stable index will feel comfortable owning an enhanced index fund. On the other hand, the fact that it is an “enhanced” index investment gives an investor the possibility of outperforming the index over time. It should be appreciated that multiple ways of purchasing a variety of interests can be combined and applied to the investment strategy of the present invention.

The method includes determining the portion of the initial investment to be allocated to an item of trade tied directly to the index and the portion the investor wants to invest in “enhancers”. The enhancement portion of the portfolio can include over-weighting the allocation of assets directed toward preferred items of trade and under-weighting the allocation of assets directed toward non-preferred items of trade assets relative to the weighting of the item of trade in the index or any other suitable measure of preference. Obviously, the more assets devoted to the enhancers, the more divergence between the performance of the index and the investment performance.

Under an exemplary embodiment, the enhanced index includes an investment in the entire DJIA by buying the Dow “Diamond” (AMEX symbol: DIA). The Diamond is an exchange-traded fund listed on the American Stock Exchange. Exchange-traded funds are a hybrid of a mutual fund and a stock. Like a traditional mutual fund, an exchange-traded fund is a single investment that allows an investor to buy a plurality of stocks. Unlike a traditional open-end mutual fund which does not trade on any stock exchange, exchange-traded funds are similar to stocks. That is, any investor can buy an exchange-traded fund simply by placing an order via the broker. Exchange-traded funds, unlike options, also have no finite life. Furthermore, unlike open-end mutual funds, exchange-traded funds can be bought and sold intraday. Finally, the fees to own exchange-traded funds are rather small, amounting to the commission to purchase the exchange-traded fund and a fairly minimal annual expense fee.

According to the investment method of the present invention, a fund or portfolio can be enhanced by combining an investment in the Dow Diamond with a purchase of stocks or LEAPS according to the investment method described above. For example, with an initial investment amount of $10,000 to invest using the investment method, one approach includes investing $8,000 in the Dow Diamonds and investing the remaining $2000 in LEAPS in one or more of the most altered value stocks as described above. If the Dow rises 8% over the year, and the portfolio of the invention increases by 30% for the year, the total $10,000 initial investment grows to $11,240 (the $8,000 in the Diamonds multiplied by the 8% return plus the $2,000 investment in LEAPS multiplied by a 30% return)—a gain of 12.4%, more than four percentage points higher than the DJIA gain of 8%. If the strategy decreases by 30%, the initial $10,000 investment (assuming the same 8% return on the DJIA) would have risen to just $10,040—a gain of 0.4%. In this instance, the investment is nearly eight percentage points worse than the DJIA. However, one would have still made a profit even though one-fifth of the investment had declined 30%. It should be appreciated that the enhanced index approach can be adjusted based on the risk parameters and the desire to stay close to the performance of the underlying index.

Another example of an enhanced index approach to the present invention uses a variation of the long/short approach discussed above. In one embodiment, instead of going long on the worst-performing stock and shorting the best-performing stock, LEAP puts and calls are used to replicate a similar bet. In this example, the investor purchases $8000 worth of Dow Diamonds, $1000 in the long LEAP (the “call” LEAP) of the DJIA stock trading the most below its two-hundred day moving average and $1000 in the short LEAP (the “put” LEAP) of the DJIA stock that is trading the greatest percentage above its two-hundred day moving average. The strike price of the LEAPS is close to the actual trading price of the underlying stock and has a lifespan of at least twelve months.

Referring back to FIG. 1, after purchasing a particular amount or interest in an altered value item of trade in a market, step S4 includes holding that interest for a predetermined period of time. One embodiment of the present invention includes holding the shares of stock for at least one year. In one embodiment the investor holds the interest in the item of trade for a period of time corresponding to optimizing the tax treatment of any gain or loss from the sale of that item of trade, such as not selling shares of stock until the next trading day after a period of twelve months from the date of purchase. For example, if an investor buys stock on February 15, the earliest the investor can sell and receive favorable capital gains tax treatment is February 16 or the next trading day following the 15th of the following year. Holding the stock for an extra day allows the investor to have any gain from the sale of the stock treated as a long-term capital gain and, under current tax law, at a more favorable rate than a gain from a sale of a stock sold within a year of its purchase. Therefore, the investment method of the present invention includes holding the investments for one year and a day under certain circumstances.

Turning short-term gains into long-term gains by holding the stocks in the portfolio an extra day after the twelve months may make a substantial difference in the return if the investor is holding the stocks in a taxable account. For example, if an investor is in the thirty-five percent income tax bracket, under current tax law, any realized gains on investments held twelve months or less will be taxed at thirty-five percent. Holding the investment for an extra day, however, converts any gain on that investment from a short term capital gain to a long-term capital gain which is taxed at a rate of fifteen percent. Therefore, if a portfolio of $10,000 realized a return of twenty percent on the investment (or a gain of $2,000) after holding the investment for twelve months or less, the gain is considered short term and is taxed at a rate of thirty-five percent—a loss of $700 to taxes. The after-tax profit then is $1,300. If the same return is realized after holding the investment for twelve months and a day or more, the gain is considered long-term and is taxed at a rate of fifteen percent—a loss of just $300 to taxes. The after-tax profit then is $1,700. Therefore, by waiting one extra day to sell the positions, the investor pockets an extra $400—or four percent of the original investment. The investment should be held the extra day to take advantage of favorable long-term capital gains tax treatment of any gains if the size of the initial investment is significant, if the investor is in a higher tax bracket, and if the investment strategy is successful in generating larger gains during that year. If the investment strategy of the present invention incurs a loss in a given year, the investor creates a short-term loss by selling after twelve months and not holding the extra day. Of course, if the investment portfolio is held in a tax-deferred account, such as a Roth IRA, the distinction between long-term and short-term gains is moot. It should be appreciated that holding the stock of the portfolio an extra day is not without risk. Indeed, if the stock price drops on the last day, one may have been better off selling and paying taxes on the short-term gain. Probabilities suggest, however, that the chances are just as good that the stock could rise on the extra day, thus enhancing returns.

If a company in which the investor has invested spins off a firm to shareholders, the investor, in one embodiment, holds the shares in the spin-off company until the end of the twelve-month holding period and then sells the spin-off. This assumes, of course, that the spin-off does not join the composite index from which stocks for the following year will be selected.

Similarly, if during the twelve-month holding period, a stock owned by the investor is dropped from the composite index, in one embodiment, the investor continues to hold the stock through the end of the twelve-month period. Although short-term selling pressures as composite “indexers” sell the dropped stock and buy the stock that is being added, in one embodiment, the investor maintains his position in the dropped stock for simplicity sake and due to the fact that the investment method of the present invention assumes a twelve-month holding period regardless of whether the stock was removed from the index.

Referring still to FIG. 1, steps S5 and S6 of the investment method include re-balancing the portfolio upon expiration of the holding period. Re-balancing the portfolio includes step S6 of identifying a new list of the altered value items of trade before step S5 of selling the altered value items of trade of the current portfolio from the previous twelve months. Again, the stable value items of trade are ranked according to their performance over the previous time period and a new set of most altered value items of trade is identified as discussed above.

It should be appreciated that one or more of the previously purchased altered value items of trade may continue to be one of the most altered value items of trade. In such a case, in one embodiment, the investor excludes the repeated most altered value item of trade from the re-balanced portfolio. Alternatively, the investor includes the repeated most altered value item of trade in the new re-balanced portfolio and continues to hold same. If the amount invested in each of the items of trade of the portfolio is being kept fairly equal as described above, the investor may have to add more dollars to those investments being held over from a prior year in order to get the weightings reasonably equal. For example, if the value of a $2,000 investment in a stock held over from the previous year has declined by $500 over the previous year, in one embodiment, the investor purchases $500 of additional shares of that stock in order to maintain equal dollar investments in each of the stocks in the portfolio. It should be appreciated, however, that it may not be efficient to incur additional trading costs to bring the weightings exactly in line if the investment in each stock differs by a relatively insignificant amount such as a few hundred dollars.

The investment method, continues in step S5 of FIG. 1, includes selling the remaining altered value items of trade. For example, as illustrated in FIG. 4, the investor buys Home Depot stock at $24.02 per share on Dec. 31, 2002 and sells the stock at $34.54 per share on Dec. 31, 2003, for a gain of 49% or $980. Intel is purchased at $15.57 per share on Dec. 31, 2002 and sold at $32.05 per share for a gain of 106.5% or $2,130. McDonalds is purchased at $16.08 per share on Dec. 31, 2002, and sold at $24.85 per share on Dec. 31, 2003 for a gain of 56.3% or $1,136. General Electric is purchased at $24.35 per share on Dec. 31, 2002, and sold at $30.98 per share on Dec. 31, 2003 for a gain of 30.7% or $614. IBM is purchased at $77.50 per share on Dec. 31, 2002 and sold at $92.98 per share for a gain of 20.5% or $410. Therefore, the total return on the $10,000 investment in a five stock portfolio in 2003 is $15,270. The investor, therefore realized a profit of $5,270 ($15,270-$10,000) or a 52.7% total return ($5,270 divided by the initial value of the investment, $10,000).

As discussed above, in one embodiment, market orders are placed to insure that the stock will be sold and the proceeds will be readily available to put into the next set of altered value items of trade of the re-balanced portfolio; Therefore, in the illustrated embodiment, after twelve months, on Dec. 31, 2003, or, alternatively, twelve months and one day, January 1 or the next trading day, the investor sells the stocks and purchases shares of stock of the five most altered value performing stocks of 2003, repeating steps S2 to S6 as illustrated in FIG. 1.

One aspect of the invention includes reinvesting any dividends earned on the stock owned. In fact, the investment strategy of the present invention assumes that all dividends are reinvested. Therefore, a portion of the return on the investment strategy includes interest paid on cash held in the trading account. To compute the portfolio return for a given year, the investor subtracts the starting investment from the total value of the portfolio on the last day of the holding period including cash, dividends, interest on dividends, etc. The profit or loss is then divided by the starting value to calculate the return.

It should be appreciated that the investment method of the present invention is preferably implemented in a software program, over a data network including an internet, video, publications or any other suitable form of communication. As an example, the investment method is implemented on a website. The website can provide support to a user by providing statistics necessary to implement the method of the present invention as well as the embodiment of the investment method.

Under the example, a website includes a list of the ten worst-performing stocks over a predetermined period of time which represent the selections at the beginning of a holding period such as a calendar year. The website can provide a list ranking the thirty DJIA stocks on twelve-month percentage price change, from the worst performer to the best, highlighting the ten worst-performing DJIA stocks over the last twelve months as illustrated in FIG. 2.

The website can also include the ten stocks with the lowest close ratios at the end of a predetermined period of time such as a calendar year. The close ratio represents the ratio of a stock's price to its moving average price over a predetermined period of time. The website can provide a list ranking the thirty DJIA stocks on the ratio of stock price to 200-day moving average price, from the lowest ratio to the highest ratio, highlighting the ten DJIA stocks with the lowest ratios as illustrated in FIG. 3.

The website may also provide examples of different portfolios including the worst-performing stocks over a predetermined period of time such as the last twelve months. Portfolios can include one-stock, three-stock, five-stock, or ten-stock portfolios. Also, the website may provide examples of different portfolios including stocks with the lowest ratio of current stock price to two hundred-day moving average price. In addition, the website can provide updated performance statistics such as percentage price change for the year to date for the portfolios and the distribution of the investment among the stocks in each portfolio.

The advantage of the present invention is that one can apply the investment method in a variety of ways and in a variety of investment vehicles according to the level of risk one wants to implement. It should be appreciated that the investment strategy of the present invention can be incorporated into a variety of broader investment approaches as well as a stand-alone portfolio. Furthermore, parts of the investment strategy of the present invention can be incorporated into a portfolio of many stocks. Moreover, the investment strategy of the present invention can be used to balance other investments that are bought or held.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of investing in a market, said method comprising,
(a) identifying at least one stable value item of trade in the market, wherein each stable value item of trade includes a stable value that is substantially stable over a predetermined period of time;
(b) identifying at least one altered value item of trade of the stable value items of trade, wherein said altered value item of trade includes an altered value that is different from its stable value;
(c) determining an amount of money to be used to purchase an interest in the altered value item of trade;
(d) buying the interest in the altered value item of trade; and
(e) selling the interest in the altered value item of trade after a predetermined holding period of time.

2. The method of claim 1, wherein the item of trade includes a security.

3. The method of claim 2, wherein the security includes at least one share of common stock.

4. The method of claim 2, wherein the item of trade includes a derivative security.

5. The method of claim 1, wherein the value includes a price per share of common stock.

6. The method of claim 1, wherein the altered value is a current value per unit in the item of trade.

7. The method of claim 1, wherein the stable items of trade in the market include components of an index of the market.

8. The method of claim 7, wherein the index includes the Dow Jones Industrial Average.

9. The method of claim 1, wherein the predetermined period of time is twelve months.

10. The method of claim 1, which includes identifying at least one altered value item of trade in the plurality of stable value items of trade based on the percent change in stable value over a predetermined period of time.

11. The method of claim 10, wherein the predetermined time period is twelve months.

12. The method of claim 10, which further includes identifying at least one altered value item of trade from the identified altered value items of trade based on the altered value of the altered value item of trade.

13. The method of claim 12, wherein the altered value item of trade includes the altered value item of trade with the lowest altered value.

14. The method of claim 1, which includes identifying at least one altered value item of trade from the stable value items of trade based on the ratio of the current price per share of a stock to a moving average price per share of a stock over a predetermined period of time.

15. The method of claim 14, wherein the predetermined time period is two hundred days.

16. The method of claim 14, which further includes identifying at least one altered value item of trade from the identified altered value items of trade based on the altered value of the altered value item of trade.

17. The method of claim 16, wherein the altered value item of trade includes the altered value item of trade with the lowest altered value.

18. The method of claim 1, wherein the altered valued item of trade includes at least one item of trade, said item of trade having a difference between its altered value and stable value that is greater than the difference between the altered value and the stable value of each of the other stable value items of trade.

19. The method of claim 1, wherein the altered value of the altered value item of trade is less than the stable value of said altered value item of trade.

20. The method of claim 1, wherein the altered value of the altered value item of trade is greater than the stable value of said altered value item of trade.

21. The method of claim 1, wherein the altered valued item of trade includes at least one item of trade having a difference between its altered value and stable value that is greater than the difference between the altered value and the stable value of each of the other stable value items of trade.

22. The method of claim 1, wherein determining an amount of money to be used to purchase an interest in a plurality of identified altered value item of trade includes dividing the amount of money substantially equally between said plurality of altered value items of trade.

23. The method of claim 1, wherein the interest in the altered value item of trade includes ownership of at least one unit of the altered value item of trade.

24. The method of claim 1, wherein the interest in the altered value item of trade includes the right to trade at least one unit of the altered value item of trade at a predetermined value.

25. The method of claim 24, wherein the interest in the altered value item of trade includes the right to sell at least one unit of the altered value item of trade at a predetermined value within a predetermined period of time, and wherein the altered value of the altered value item of trade is greater than the stable value of said altered value item of trade.

26. The method of claim 1, wherein the interest in the altered value item of trade includes at least one option to sell the item of trade at a predetermined price per share within the predetermined holding time period.

27. The method of claim 1, wherein the interest in the altered value item of trade includes at least one option to buy at least one share of common stock at a predetermined price per share within the predetermined holding time period.

28. The method of claim 1, wherein the predetermined holding time period is based on optimizing the tax treatment of any gain or loss from a sale of said interest.

29. The method of claim 1, wherein the predetermined holding time period is twelve months and one day.

30. The method of claim 1, which includes selling said interest in the altered value item of trade if the altered value reaches a predetermined price per share.

31. The method of claim 1, which includes repeating said method upon selling said interest in the altered value item of trade after a predetermined holding time period.

32. An apparatus for investing in a market, comprising: a processor; and a memory storing instructions adapted to be executed by said processor to:
(a) identify at least one stable value item of trade in the market, wherein each stable value item of trade includes a stable value that is substantially stable over a predetermined period of time;
(b) identify at least one altered value item of trade of the stable value items of trade, wherein said altered value item of trade includes an altered value that is different from its stable value;
(c) determine an amount of money to be used to purchase an interest in the altered value item of trade;
(d) buy the interest in the altered value item of trade; and
(e) sell the interest in the altered value item of trade after a predetermined holding period of time.

33. A system for investing in a market comprising:
(a) means for identifying at least one of stable value items of trade in the market, wherein each stable value item of trade includes a stable value that is substantially stable over a predetermined period of time;
(b) means for identifying at least one altered value item of trade of the stable value items of trade, wherein said altered value item of trade includes an altered value that is different from its stable value;
(c) means for determining an amount of money to be used to purchase an interest in the altered value item of trade;
(d) means for buying the interest in the altered value item of trade; and
(e) means for selling the interest in the altered value item of trade after a predetermined holding period of time.
